(19) United States
(12) Patent Application Publication
(10) Pub. No.: US 2003/0169428 A1
(43) Pub. Date: Sep. 11, 2003

(54) Saw tooth bias modulation and loop closure for an interferometric fiber optic gyroscope

(75) Inventor: Charles Lange, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/078,182

(22) Filed: Feb. 19, 2002

(51) Int. Cl. G01C 19/72

(52) U.S. Cl. 356/464

(57) ABSTRACT

A fiber optic gyroscope with counter-propagating electromagnetic waves in a fiber-optic coil senses rotation about the coil. Such a fiber-optic gyroscope uses a bias modulation to bias the gyroscope on a rate sensitivity portion of the interferogram. Using a saw-tooth waveform as the bias modulation results in a system with many advantages over a system modulated by square waves or sinusoidal wave. For example, the system is less sensitive to cross coupling because the drive is significantly different than the detected signal. In addition, the saw-tooth waveform can be used in a closed loop scheme with the advantage of a frequency output proportional to the rate and a reduction or elimination of the known causes of dead band in a closed loop gyro.

### BACKGROUND OF THE INVENTION

1. Technical Field

The present invention relates to fiber optic gyroscopes, and more particularly to methods of operating a fiber optic gyroscope in both closed-loop and open-loop configurations using a saw-tooth modulation signal in a fiber coil.

2. Background Information

Gyroscopes have typically been mechanical devices that use a spinning wheel. In a traditional mechanical gyroscope, the spinning wheel has a tendency to maintain its orientation even if the framework supporting the gyroscope is moved. By measuring the movement of the framework with respect to the axis of the gyroscope, one is able to determine the movement of the framework. By rigidly mounting the framework to a vehicle, such as a ship, aircraft, or automobile, one is able to determine the movement of the vehicle.

While mechanical gyroscopes have been used for many years, there has been a desire to be able to measure the movement or rotation of an object without the use of moving parts. One such device used to measure the movement uses light to determine movement: such a device is called a fiber optic gyroscope.

Fiber optic gyroscopes can sense rotation of the object supporting the fiber optic gyroscope. Such gyroscopes can be made quite small and can be constructed to withstand considerable mechanical shock, temperature change, and other environmental extremes. Due to the absence of moving parts, they can be nearly maintenance free, and they have the potential of becoming economical in cost. They can also be sensitive to low rotation rates that are difficult to detect in other kinds of gyroscopes. The operation of a fiber optic gyroscope is more fully described below.

A known fiber optic gyroscope, as shown in FIG. 1a, has a coiled optical fiber wound on a core 10 and about its axis around which rotation is sensed. The optical fiber typically is between 50 and 2,000 meters long and is part of a closed optical path in which an electromagnetic wave is introduced and split into a pair of such waves to propagate in clockwise (cw) and counter clockwise (ccw) directions through the coil to both ultimately impinge on a photodetector. Rotation Ω about the sensing axis of the core, or the coiled optical fiber 10, provides an effective increase in optical path length in one rotational direction and a decrease in optical path length in the other rotational direction for one of these waves. The opposite result occurs for rotation in the other direction. Such path length differences between the waves introduce a phase shift between these waves for either rotation direction; this is known as the Sagnac effect.

This gyroscope is known as an interferometric fiber optic gyroscope (IFOG). The coiling of the optical fiber is desirable because the amount of phase difference shift due to rotation is dependent on the length of the entire optical path through the coil traversed by the two electromagnetic waves traveling in opposite directions. Therefore, a large phase difference can be obtained in a long optical fiber that occupies a relatively small volume as a result of being coiled.

The output light intensity impinging on the photodetector (13, 14) (and hence the current emanating from the photodetector system photodiode (PD), in response to the electromagnetic waves traveling in the opposite direction impinging on the photodiode after passing through the coiled optical fiber) follows a raised cosine function. In other words, the output current depends on the cosine of the phase difference (φ) between these two waves, as shown in FIG. 2. Since a cosine function is an even function, such an output function gives no indication as to the relative directions of the phase difference shift, as the cosine function is symmetrical about zero. In addition, the rate of change of a cosine function near zero phase is very small. Therefore, such an output function provides undesirably low sensitivity for low rotation rates.

Because of these characteristics, the phase difference between the two counter-propagating electromagnetic waves may be modulated by placing an optical phase modulator, or bias modulator, in the optical path on one side of or adjacent to one side of the coiled optical fiber. In order to achieve sensitive detection of rotation, the Sagnac interferometer is typically biased at frequency f_{b} by a sinusoidal or square-wave modulation of the differential phase between the counter-propagating beams within the interferometric loop. As a result, one of these oppositely directed propagating waves passes through the modulator on the way into the coil while the other wave, traversing the coil in the opposite direction, passes through the modulator upon exiting the coil at a time later equivalent to the loop transit time.

In addition, a phase sensitive detector (PSD), serving as part of a demodulator system, or, in the alternative, a digital demodulator, is provided to receive a signal representing the photodetector output current. Both the digital demodulator and the phase sensitive detector can be operated by the modulation signal generator or a synchronized derivative of it at the so-called “proper” frequency (also known as the “Eigen” frequency) to reduce or eliminate modulator introduced amplitude modulation.

The “proper” frequency is the modulation providing 180 degrees of phase difference between the two counter-propagating waves: this has the effect of eliminating modulator introduced amplitude modulation of the resulting photodetector signal. The value of the “proper” frequency can be determined from the length of the optical fiber and the equivalent refractive index for it.

FIGS. 3a, 3b, and 4 show the effect of modulation and demodulation over the known raised cosine function. In FIGS. 3a and 3b, the phase difference, Δφ, of the gyro optical waves are modulated with a sine wave bias modulation for the cases of Ω=0 and Ω≠0, respectively, where Ω is the rotation rate about the sensing axis; Ω=0 signifies no rotation about the sensing axis. The resulting modulated intensity output of the photodetector versus time is shown to the right of the raised cosine function. As FIGS. 3a and 3b show, for Ω=0, the phase modulation is applied symmetrically about the center of the raised cosine function and for Ω≠0, the phase modulation is applied asymmetrically. In the first case, the outputs at points A and B are equal, giving only even harmonics of f_{b} on the photodetector output. In the second case, the outputs at A and B are unequal, giving significant photodetector signal content at f_{b}, which is indicative of rotation rate. This signal content at f_{b}, recovered by the phase sensitive demodulator (PSD) is proportional to the rotation rate Ω. The signal also changes sign for rotation in the opposite direction.

FIGS. 4a and 4b show the case of a known square wave modulation for Ω=0 and Ω≠0, respectively. Here, in practice, square wave phase modulation produces phase difference modulation that is also a square wave. The square wave phase difference modulation produces a transient by the value of switching Δφ from point A to point B on the raised cosine function. These are shown by the vertical lines in the resultant modulated photodetector current versus time, which is proportional to the optical intensity impinging on the photodetector for an ideal photodetector. Again, in the absence of rotation, the output at points A and B are equal, while the presence of rotation makes the output unequal for the “A” half periods and “B” half periods. In the square wave demodulation process depicted in FIGS. 5a, 5b and 5c, the signal component synchronous with the bias modulation frequency f_{b} is recovered from the photodetector signal by multiplying by a square wave demodulator reference waveform of zero mean, synchronized to the bias modulation. The average, or DC component of the resultant demodulated output is proportional to rotation rate.

In all of these cases, the output of the PSD is an odd function having a large rate of change at zero phase shift, and changes algebraic sign on either side of zero phase shift. Hence, the PSD signal can provide an indication of which direction a rotation is occurring about the axis of the coil, and can provide the large rate of change of signal value as a function of the rotation rate near a zero rotation rate, i.e., the detector has a high sensitivity for phase shifts near zero so that its output signal is quite sensitive to low rotation rates. This is possible, of course, only if errors are sufficiently small. In addition, this output signal is approximately linear at relatively low rotation rates. Such characteristics for the output signal of the PSD are a substantial improvement over the characteristics of the output current of the photodetector without optical phase modulation.

The know fiber optic gyroscope according to FIG. 1a is described in greater detail below.

The optical portion of the known system contains several features along the optical paths to assure that this system is reciprocal, i.e., that substantially identical optical paths occur for each of the counter-propagating electromagnetic waves except for the specific introductions of non-reciprocal phase difference shifts, as will be described below. As stated above, the optical fiber forms a coil 10 about a core or spool using a single mode optical fiber wrapped about the axis around which rotation is to be sensed. The use of a single mode fiber allows the paths of the electromagnetic or light waves to be defined uniquely, and further allows the phase fronts of such a guided wave to also be defined uniquely. This greatly aids maintaining reciprocity.

The electromagnetic waves that propagate in opposite directions through coil 10 are provided from an electromagnetic wave source, or light source 11, in FIG. 1a. This source is a broadband light source, typically a semiconductor superluminescent diode or a rare earth doped fiber light source that provides electromagnetic waves, typically in the near-infrared part of the spectrum, over a range of typical wavelengths between 830 nanometers (nm) and 1550 nm. Source 11 must have a short coherence length for emitted light to reduce the phase shift difference errors between these waves due to Rayleigh and Fresnel scattering at scattering sites in coil 10. The broadband source also helps to reduce errors caused by the propagation of light in the wrong state of polarization.

With reference to FIG. 1a, between light source 11 and fiber optic coil 10, there is an optical path arrangement formed by the extension of the ends of the optical fiber forming coil 10 to some optical coupling components that separate the overall optical path into several optical path portions. A portion of optical fiber is positioned against light source 11 at a point of its optimum light emission, a point from which it extends to a first optical directional coupler (“source-detect coupler”) 12 which may also be referred to as an “optical light beam coupler” or wave “combiner/splitter coupler”.

Source-detect coupler 12 has light transmission media in it which extend between four ports, two on each end of that media, and which are shown on each end of the coupler 12 in FIG. 1a. One of these ports has the optical fiber extending from light source 11 positioned against it. At the other port on the sense end of the source-detect coupler 12 is a further optical fiber positioned against it which extends to be positioned against a photodiode 13 which is electrically connected to a photodetection system 14.

Photodiode 13 is configured to detect electromagnetic waves, or light waves, impinging from it from the portion of the optical fiber positioned against it and provides a photocurrent in response to a signal component selector 35. This photocurrent, as indicated above, in the case of two nearly coherent light waves impinging on it, follows a raised cosine function in providing a photocurrent output that depends on the cosine of the phase difference between such a pair of substantially coherent light waves. This photodetector device will operate into a very low impedance to provide the photo current which is a linear function of the impinging radiation, and may typically be a p-i-n photodiode.

Source-detect coupler 12 has another optical fiber against a port at the other end (opposite the sense end) which extends to a polarizer 15. At the other port on that same side of coupler 12 there is a non-reflective termination arrangement 16, involving another portion of an optical fiber. The optical directional source-detect coupler 12, in receiving electromagnetic waves, or light, at any of its ports, transmits such light so that approximately half of it appears at each of the two ports of coupler 12 on its end opposite that end having the incoming port. On the other hand, no such waves or light is transmitted to the port which is on the same end of coupler 12 as is the incoming light port.

Polarizer 15 is used because, even in a single spatial mode fiber, light may propagate in two polarization modes through the fiber. Thus, polarizer 15 is provided for the purpose of passing light propagating of one polarization such that clockwise (cw) and counter clockwise (ccw) waves of the same polarization are introduced into sensing loop 10 and only light from the sensing loop of the same polarization for the cw and ccw waves are interfered at the detector. Polarizer 15, however, does not entirely block light in the one state of polarization that it is intended to block. Again, this leads to a small non-reciprocity between two counter-propagating electromagnetic waves passing through it and so a small non-reciprocal phase shift difference occurs between them which can vary with the conditions of the environment in which polarizer 15 is placed. In this regard, the high birefringence in the optical fiber used or the broad bandwidth of the light source used again aids in reducing this resulting phase difference, as indicated above.

Polarizer 15 has a port on either end with the electromagnetic wave transmission medium contained within and positioned between its ends. Another optical fiber portion, positioned against the port on the end opposite that connected to optical directional source-detect coupler 12, extends to a further optical bidirectional coupler (“sensing coil coupler”) 17 which has the same wave transmission properties as does source-detect coupler 12.

The port on the same end of the sensing coil coupler 17 from which a port is coupled to polarizer 15 again is connected to a non-reflective termination arrangement 18, using a further optical fiber portion. One of the ports on the other end of the sensing coil coupler 17 is connected to further optical components in the optical path portions extending to it from one end of the optical fiber in coil 10. The other port in the sensing coil coupler 17 is directly coupled to the remaining end of optical fiber 10. An optical phase modulator 19 is provided between coil 10 and the sensing coil coupler 17, on the side of coil 10 opposite its directly connected side. Optical phase modulator 19 has two ports on either end of the transmission media contained within, shown on its opposite ends in FIG. 1a. The optical fiber from coil 10 is positioned against a port of modulator 19. The optical fiber extending from the sensing coil coupler 17 is positioned against the other port of modulator 19.

Optical modulator 19 is capable of receiving electrical signals to cause it to introduce a phase difference in electromagnetic waves transmitted through it by either changing the index of refraction or the physical length of the transmission medium to change the optical path length. Such electrical signals are supplied to modulator 19 by a bias phase modulation signal driver/generator 20 providing either a sinusoidal voltage output signal at a modulation frequency f_{b} that is intended to be equal to C₁ sin (ω_{b}t) where ω_{b} is the radian frequency equivalent of the modulation frequency f_{b} and C₁ is the amplitude of the modulation, or a square wave modulation signal at f_{b}.

This completes the description of the optical portion of the system of FIG. 1a formed along the optical path followed by the electromagnetic waves, or light waves, emitted by source 11. Such electromagnetic waves are coupled from that source 11 through the optical fiber portion to optical directional source-detect coupler 12. Some of such waves entering coupler 12 from source 11 is lost in non-reflecting terminating arrangement 16 coupled to a port on its opposite end, but the rest of that wave is transmitted through polarizer 15 to the optical directional sensing coil coupler 17.

The sensing coil coupler 17 serves as a beam-splitting apparatus in which electromagnetic waves entering its port, received from polarizer 15, split approximately in half with one portion passing out of each of the two ports on the opposite ends of the coupler 17. Out of one port on the opposite end of the sensing coil coupler 17, an electromagnetic wave passes through optical fiber coil 10, modulator 19, and back to coupler 17. There, a portion of this returning wave is lost in non-reflective arrangement 18 connected to the other port on the polarizer 15 connection end of the sensing coil coupler 17, but the rest of that wave passes through the other port of the sensing coil coupler 17 to polarizer 15 and to source-detect coupler 12 where a portion of it is transmitted to photodiode 13. The other part of the wave passed from polarizer 15 to coil 10 leaves the other port on the coil 10 end of the sensing coil coupler 17, passes through modulator 19, and optical fiber coil 10 to re-enter the sensing coil coupler 17 and, again, with a portion of it following the same path as the other portion to finally impinge on photodiode 13.

As indicated above, photodiode 13 provides an output photocurrent i proportional to the intensity of the two electromagnetic waves or light waves impinging on it, and is therefore expected to follow the cosine of the phase difference between these two waves impinging on that diode. For sinusoidal bias modulation, the photodiode signal is given by the following equation:

i=lₒ/2η[1+cos (φ_{R}+φ_{b} cos ω_{b}t)] (1)

where lₒ is the light intensity magnitude at photodetector 13 in the absence of any phase difference between counter clockwise waves and η is the detector responsivity coefficient. This is because the current depends on the resulting optical intensity of the two substantially coherent waves incident on photodiode 13, an intensity which will vary from a peak value of lo to a smaller value depending on how much constructive or destructive interference occurs between the two waves. This interference of waves will change with rotation of coil 10 about its axis as such rotation introduces a phase difference shift φ_{R} between the waves. Furthermore, there is an additional variable phase shift introduced in this photodiode output current by modulator 19 with an amplitude value of φ_{b} and which is intended to vary as cos (ω_{b}t).

For the case of square wave modulation, the photodiode current is represented by

i=½ηlₒ[1+cos (φ_{R}+φ_{b})] (2)

Where the amplitude of the phase difference modulation is

|φ_{b}|, for nT≦t<(n+½)T

−|φ_{b}|, for (n+½)T≦t<(n+1)T

where n=0, 1, 2, 3 . . . , and where T is the bias modulation period.

Optical phase modulator 19 is of the kind described above and is used in conjunction with a phase sensitive detector (PSD) or digital demodulator 23 as part of an overall detection system for converting the output signal of the photodetection system 14, following a cosine function as indicated above, to a signal function that provides in that output signal, as indicated above, information both as to the rate of rotation and the direction of that rotation about the axis of coil 10.

Thus, the output signal from photodetection system 14, including photodiode 13, is converted to a voltage and provided through an amplifier 21, where it is amplified and passed to PSD/digital demodulator 23. Photodetection system 14, amplifier 21, and PSD/digital demodulator 23 constitute a signal component selector 35. PSD/digital demodulator 23, serving as part of a phase demodulation system, is a well known device. Such a PSD/digital demodulator 23 extracts the amplitude of the fundamental frequency f_{b} of the photodiode 13 output signal, or the fundamental frequency of the bias phase modulation signal driver 20 plus higher odd harmonics, to provide an indication of the relative phase of the electromagnetic waves impinging on photodiode 13. This information is provided by PSD/digital demodulator 23.

Bias modulator signal driver 20, in modulating the light in the optical path at the frequency f_{b} described above, also leads to harmonic components being generated by the recombined electromagnetic waves in photodetection system 14.

In operation, the phase difference changes in the two counter-propagating electromagnetic waves passing through coil 10 in the optical path, because of rotation, will vary relatively slowly compared with the phase difference changes due to optical phase modulator 19. Any phase differences due to rotation, or the Sagnac effect, will merely shift the phase differences between the two electromagnetic waves. The amplitude of the modulation frequency component of the output signal of photodetection system 14, is expected to be set by the magnitude of this phase difference modified further only by the following factors: a) the amplitude value of the phase modulation of these waves due to optical phase modulator 19 and driver 20, and b) a constant representing the various gains through the system. Then, the periodic effects of this sinusoidal modulation due to driver 20 and modulator 19 in this signal component are expected to be removed by demodulation in the system containing PSD/digital demodulator 23 leaving a demodulator system (detector) output signal that depends on just the amplitude scaling factor. This output signal is provided to a rotation indicator 26 that may be used by other systems or provided as a form of instrumentation.

Previously, the modulation introduced by modulator 19 has been described as being a sine wave or a square wave. However, this approach does not provide the most advantageous configuration for an interferometric fiber optic gyroscope due to electrical cross coupling and susceptibility to dead band when the gyro is used at low rates.

### SUMMARY OF THE INVENTION

The object of the invention is to provide a saw-tooth wave generator and supporting hardware and software for the saw-tooth modulation of the optical signal for the above-described gyroscope and a method of utilizing this saw-tooth wave generator and modulation. Embodiments of the present invention may utilize the saw-tooth wave bias modulation signal in both open loop and closed loop configurations. The use of a saw-tooth modulation has several advantages over the above-mentioned modulation techniques. First, the use of the saw-tooth modulation signal reduces the effects of electrical cross coupling. In the case of square wave modulation, the demodulation is performed using an identical function as the bias modulation and therefore any coupling between the bias signal and the gyro output will be in error. The saw-tooth modulation can also use a square wave demodulation, in as much as the modulation and demodulation signals are different the new technique has a reduced cross-coupled error. As a result, the cross-coupled modulation signal will not contain the exact signal of the demodulation reducing therefore will reduce the potential for cross coupling error.

Although the present invention makes use of the saw-tooth waveform as a preferred embodiment, the use of any system in which the bias modulation and the demodulation are not identical so as to reduce the potential for cross coupling is contemplated as being within the scope of the invention. Other schemes are described in the patent application identified by the Honeywell reference number H17-25172, filed concurrently herewith and incorporated by reference.

Another advantage is realized when the gyro is used at low rates: the use of a saw-tooth results in less susceptibility to dead band. Dead band is a phenomenon that occurs at near zero rates when the gyro, operating in closed loop, cannot sense the rate. There are several possible causes, the most probable is a feedback voltage dependent error. For this error to cause a problem, the feed back voltage will produce an error that exactly cancels the rate locking the feedback to that voltage. The saw-tooth modulation, when used in a closed loop configuration, is not susceptible to a voltage dependent error because it operates over a fixed voltage range. In closed loop operation, varying the frequency of the saw-tooth modulation closes the feedback loop there for any voltage dependent errors will not lockup the feedback as it does in other closed loop schemes. The saw-tooth modulation can be used to determine the loop delay time. When the gyro is not sensing rate, the modulation scheme produces a signal that is directly proportional to the difference between the modulation frequency and the proper frequency of the gyro. The frequency of the modulation when the output signal is nulled is a direct measure of the proper frequency or inverse of the loop transit time.

### BRIEF DESCRIPTION OF THE DRAWINGS

The invention is further described in connection with the accompanying drawings, in which:

FIG. 1a is a block schematic diagram showing a known basic interferometric fiber optic gyroscope;

FIG. 1b is a block schematic diagram showing the inventive elements for an embodiment of the interferometric fiber optic gyroscope;

FIG. 2 is a graph of detected optical intensity or output current of a photodetector versus phase difference of counter-propagating light waves in the sensing coil of a fiber optic gyroscope;

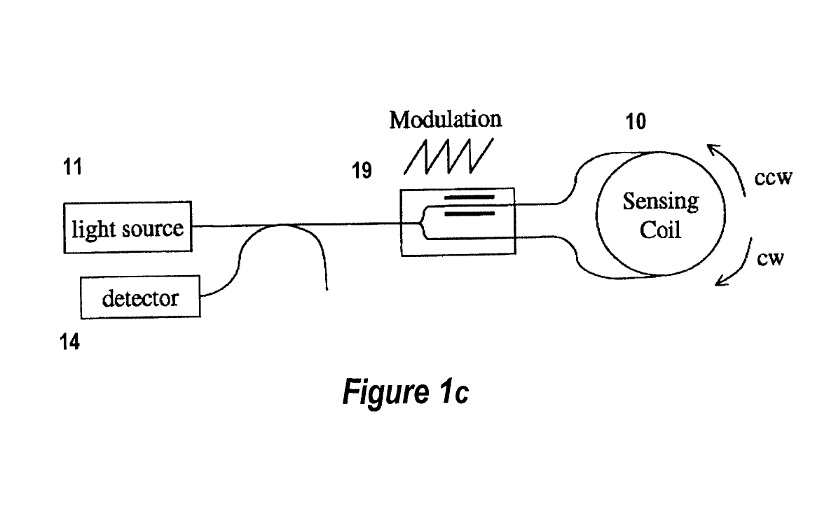

FIGS. 3a and 3b are graphs showing the phase differences of the optical light waves and outputs of the gyroscope for zero and non-zero rotation rates, respectively, using a known sinusoidal wave modulation signal;

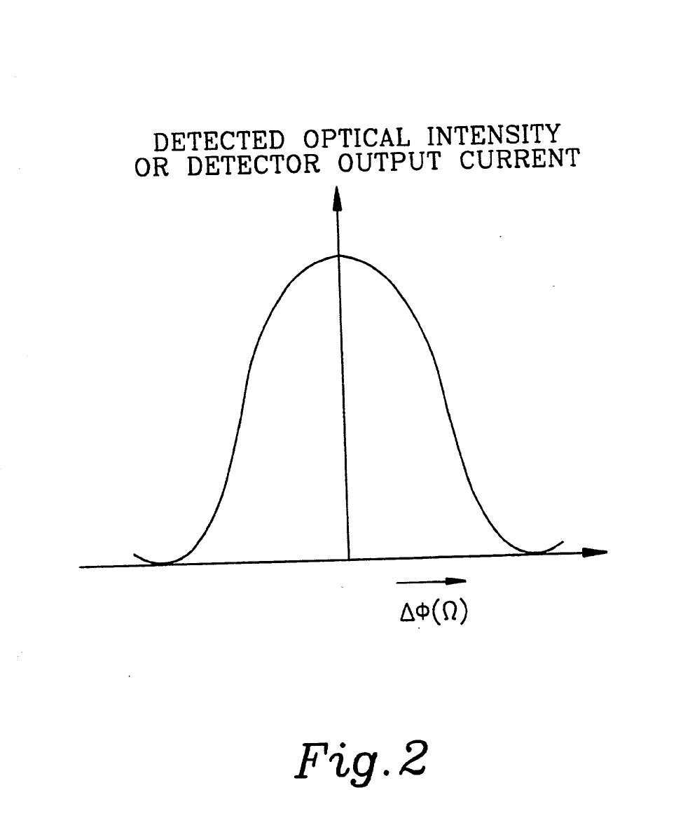

FIGS. 4a and 4b are graphs showing the phase differences of the optical waves and outputs of the gyroscope for zero and non-zero rotation rates, respectively, using a known square wave modulation signal;

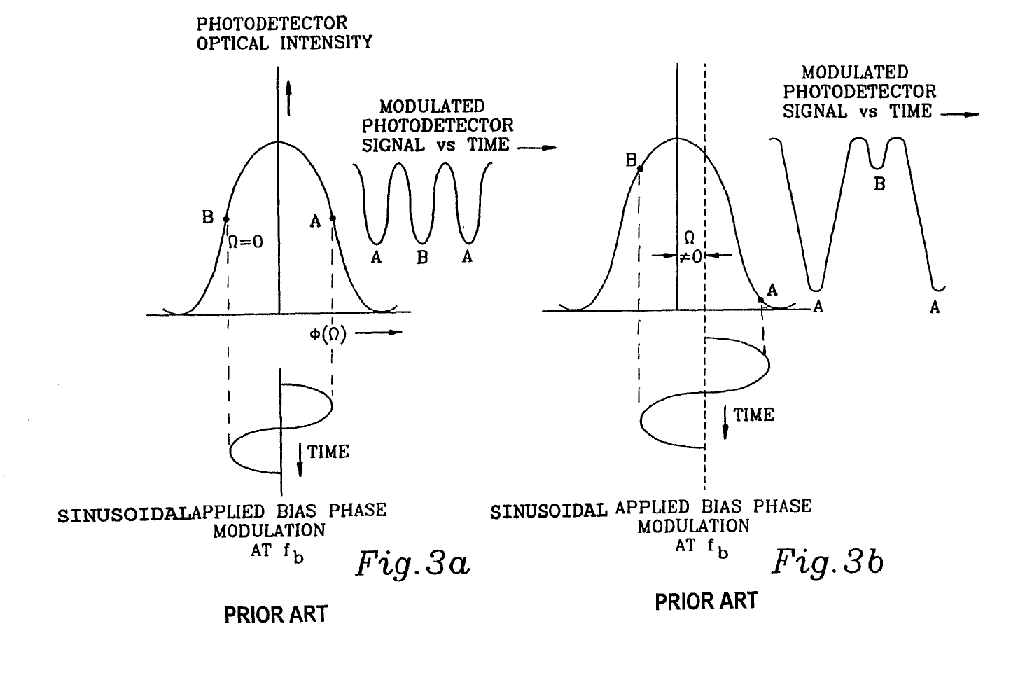

FIGS. 4c and 4d are graphs showing the phase differences of the optical waves and outputs of the gyroscope for zero and non-zero rotation rates, respectively, using the inventive saw-tooth wave modulation signal;

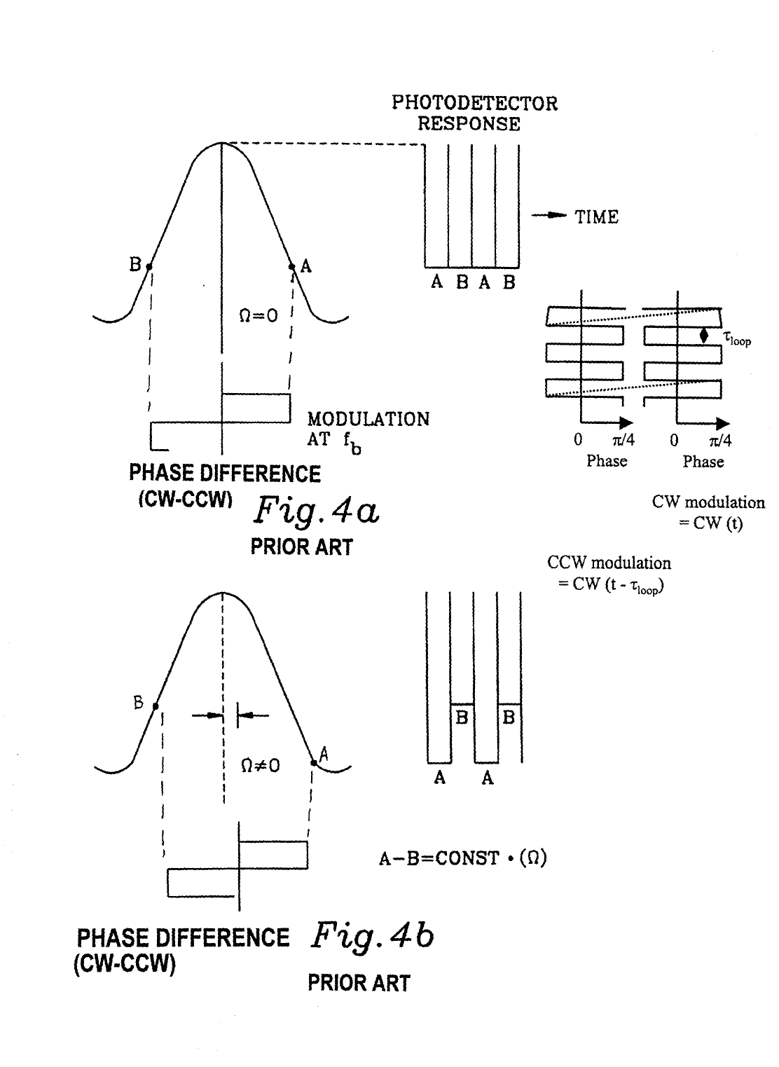

FIGS. 5a, 5b, and 5c are graphs showing a square wave demodulation process;

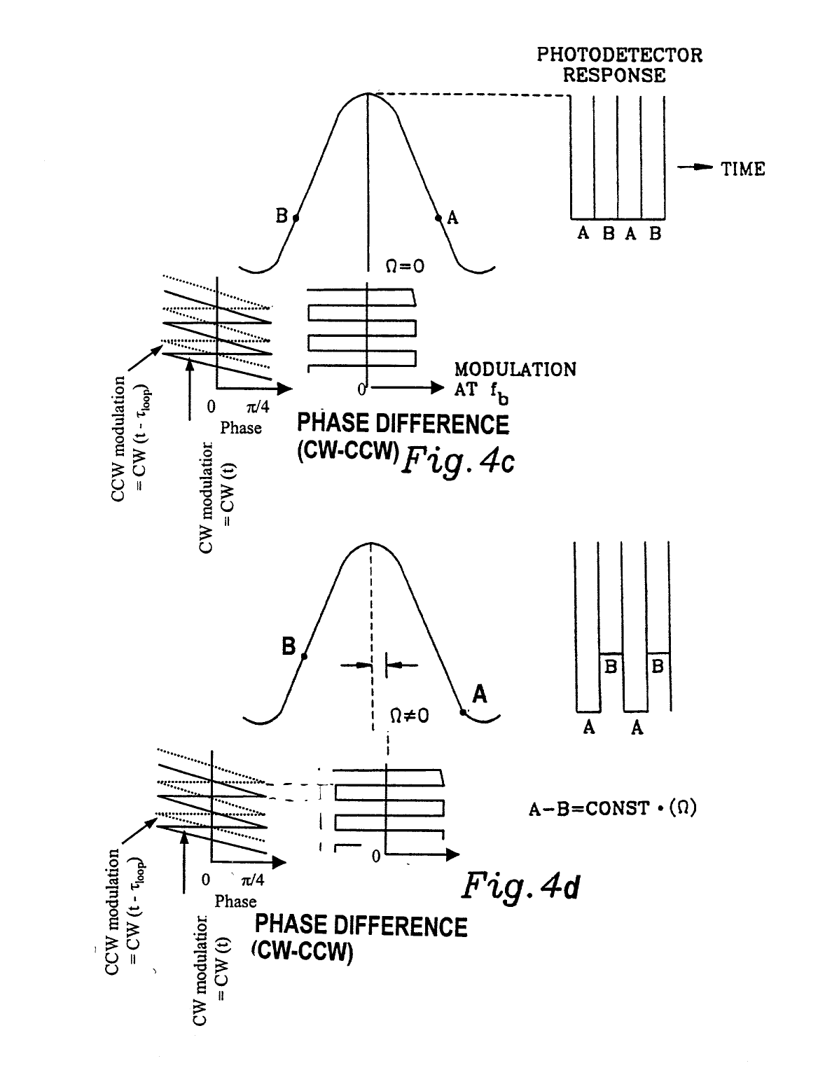

FIG. 6 is a graph showing the saw-tooth wave generated by an exemplary embodiment;

FIG. 7 is a graph showing the phase difference between the wave shown in FIG. 6;

FIGS. 8 and 9 are graphs showing, for the saw too bias modulation, a more detailed view of the saw-tooth wave generated by an exemplary embodiment with the phase difference, including the interferogram produced; and

FIGS. 10 and 11 are graphs showing, for saw tooth loop closure, a more detailed view of the saw-tooth wave generated by an exemplary embodiment with the phase difference and the interferogram produced.

### DETAILED DESCRIPTION OF THE INVENTION

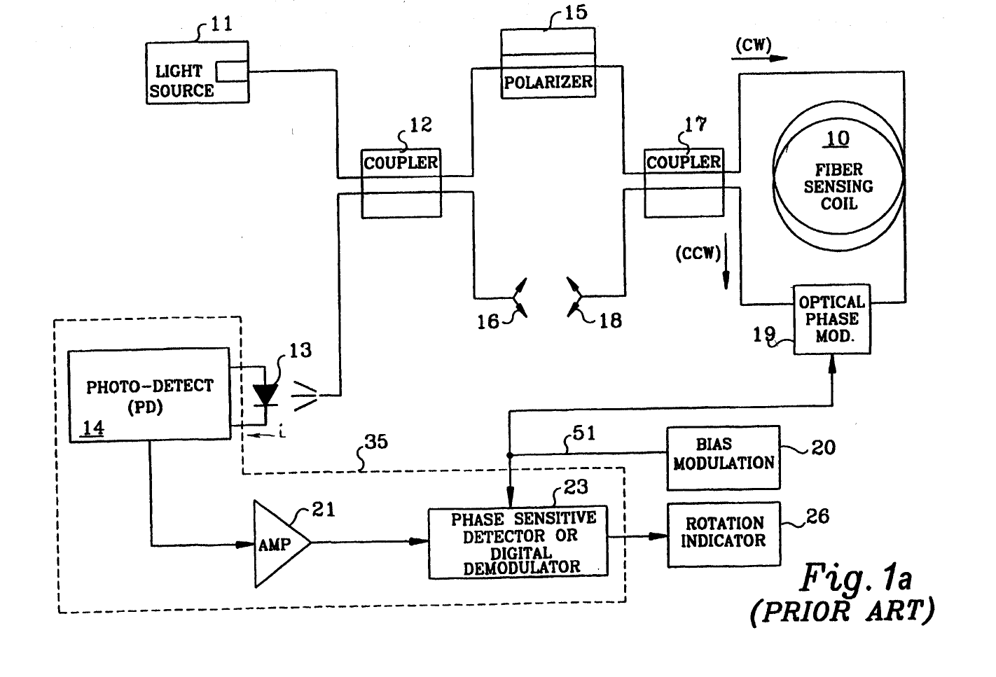

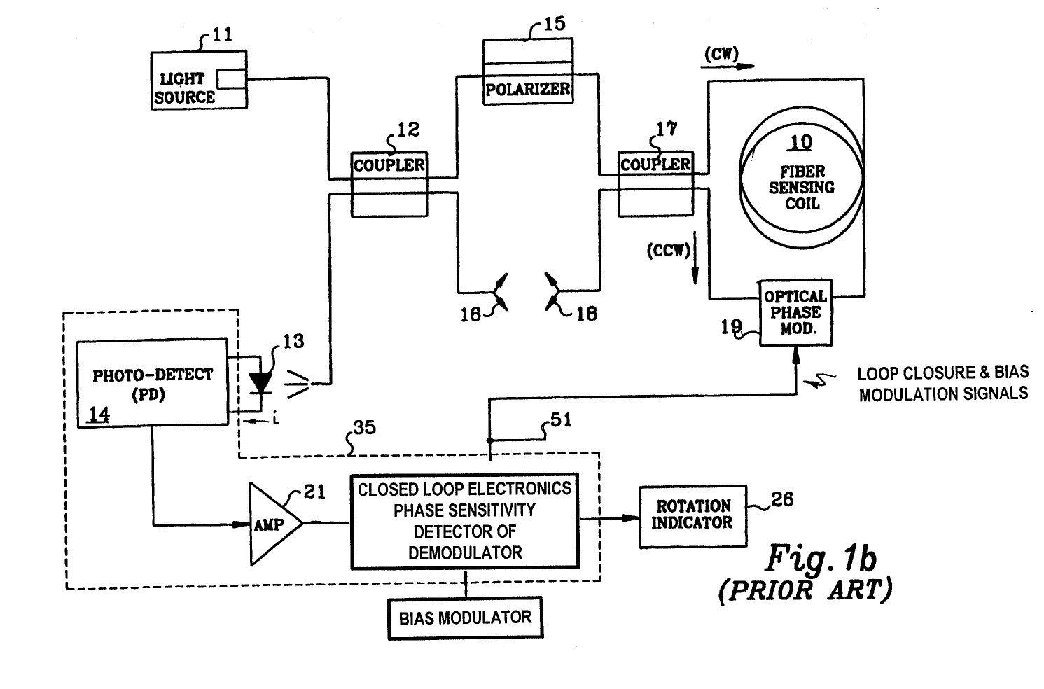

The operation of a saw-tooth modulation in the open-loop configuration is described below. As shown in FIG. 1a, but using the inventive modulation shown in FIG. 1b, the electromagnetic energy traveling counter-clockwise passes through phase modulator 19 before the energy in the clockwise loop passes through phase modulator 19. Thus, both interfering waves carry the same phase modulation, φₘ(t), but shifted in time. The delay is equal to the difference (Δτ_{g}) of group transit time between the long and short paths that connect the modulator and the splitter. The bias modulation of the phase difference is thus:

Δφₘ(t)=φₘ(t)−φₘ(t−Δτ_{g})

The equation for the bias modulation using a saw-tooth wave is

φₘ(t)=2A*fₚ*t−2A*int(fₚ*t),

where the int( ) function returns the integer portion of the operand and A is the desired amplitude of the difference modulation.

The counter-propagating wave passes through the modulator at a different time and returns a value of φₘ(t−τ_{L}) which is equal to the following:

φₘ(t−τ_{L})=2A*fₚ*(t−τ_{L})−2A*int(fₚ*(t−τ_{L}))

Thus, the phase difference, Δφₘ, between the counter-propagating waves at the proper frequency of the gyroscope, fₚ=1/(2τ_{L}) is as follows:

2Afₚτ_{L}−2A(int(fₚt)−int(fₚ(t−τ_{L}))

which equals,

A−2A(int(fₚt)−int(fₚt−0.5)).

For values of t between (n/fₚ) and ((n+0.5)/fₚ), where n is a positive integer, the phase difference, Δφₘ, is equal to −A. For values of t between ((n+0.5)/fₚ) and ((n+1/fₚ)), the phase difference, Δφₘ, is equal to A. That is, the difference in phase modulation alternates between −A and A in a periodic fashion. In other words, the difference in phase modulation is similar to that of a square wave with a period of 2τ_{L}. Thus, the modulated phase of the optical wave in the gyroscope behaves in a similar manner to the use of a square wave modulation.

There are certain phase modulation depths that are to be avoided because the resulting signal form the gyro will be insensitive to rate. These operating depths, A, include all integer multiple of π. There for it is desirable to avoid a saw tooth modulation with phase amplitude of 2π, 4π, or other even multiples of π.

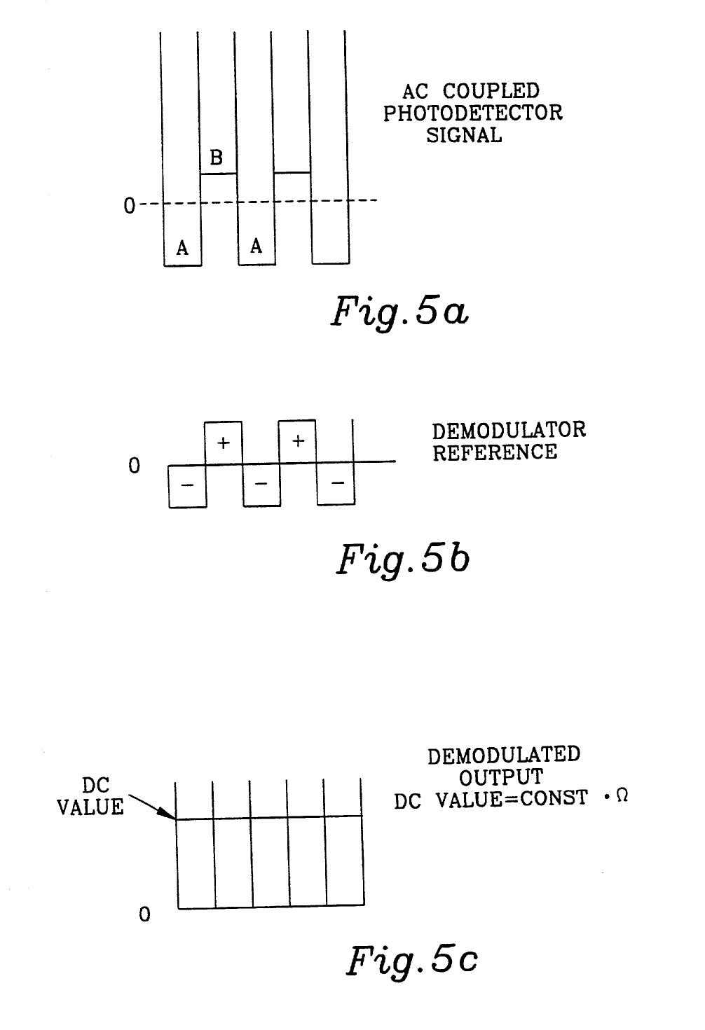

FIG. 6 graphically shows the saw-tooth wave generated by an embodiment of this invention. Wave 601 is the saw-tooth wave as the counter-clockwise loop passes through phase modulator 19. Wave 603 is the saw-tooth wave as the clockwise loop passes through phase modulator 19.

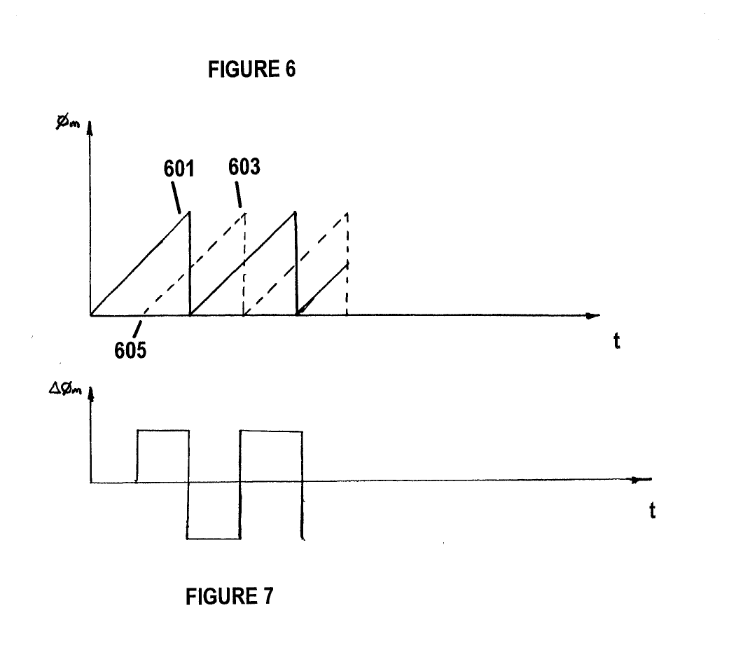

FIG. 6 indicates that wave 601 is out of phase with wave 603. The difference between the two waves is shown in FIG. 7, in which one can see that this phase difference approximates a square wave, as shown in the equations above. The bias depth is varied by varying the saw-tooth amplitude.

Thus, the saw-tooth bias modulation has all the advantages of square-wave bias modulation (the advantages of which are known in the art and described above), and also has several additional advantages over the square wave (as also described above).

Closed Loop Configuration

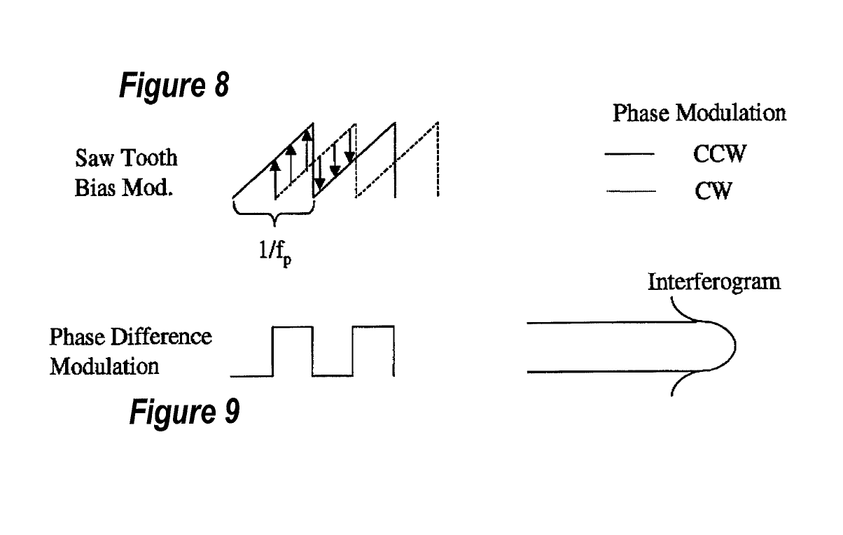

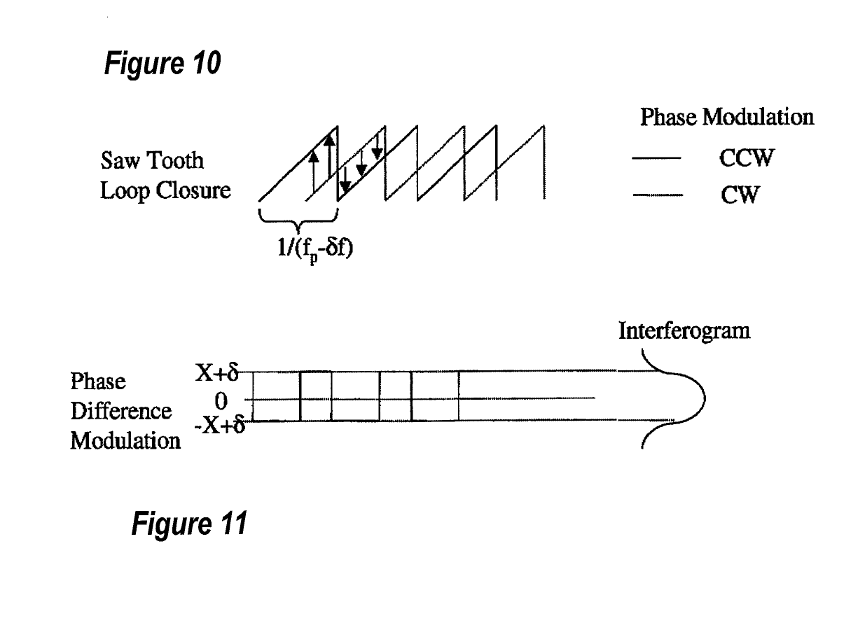

The embodiment detailed above is the open-loop operation of an embodiment of the present invention (FIGS. 8 & 9). However, a fiber-optic gyroscope can also be configured to operate in a closed-loop configuration (FIGS. 10 & 11). The closed-loop operation of a fiber-optic gyroscope solves several problems that are present in the open-loop operation. The open-loop configuration is most sensitive when biased around π/2 radians phase shift and around zero rate; at rotation rates further from zero, the output becomes less and less linear. It may be more desirable if the gyroscope were equally sensitive throughout its operating range, as the measurement of interest includes the integrated angle of rotation as well as the rate of rotation. Furthermore, the output of an open-loop fiber-optic gyroscope is sinusoidal, while a linear output is more accurate and desirable.

Advantages of the closed loop system include the fact that the output of this system is a frequency that can be easily interfaced with a frequency counter. A simple single signal is required for both bias and loop closure. Also, the drive is significantly different than the detected signal which reduces the sensitivity to cross coupling. Finally, this system uses the same range of the DAC for every bias modulation/loop closure cycle and thus is immune to reported dead zone causes.

In general terms, a closed-loop configuration of a gyroscope induces the use of a phase equal in magnitude and opposite in sign with respect to the Sagnac phase induced by rotation into the gyroscope, to force the total phase difference to zero. This may be accomplished, for example, through the use of an additional phase modulator near the coil in an optical path portion used by the counter-propagating electromagnetic waves, or other mechanisms known in the art.

This additional phase modulator may be operated in a feedback loop from the photodetector system, and provides sufficient negative feedback such that the phase modulator introduced frequency shift produces a net differential phase change that is just enough to cancel the phase shift difference between the counter-propagating electromagnetic waves resulting from the rotation about the axis of the coiled optical fiber. Operation of the system is thus centered around zero optical phase shift, where the system is most sensitive and response can be maintained as linear. In a closed-loop configuration, the measurement of interest would be the feedback signal introduced into system (Δφ_{FB}) to force the total phase in the system to zero.

The saw-tooth modulation described above may also be used in the closed-loop configuration. The aim of the closed-loop configuration is to cancel the rate induced Sagnac phase shift and output a signal that is proportional to the induced phase shift. Other gyroscopes have traditionally output a frequency proportional to the phase shift, which has the advantage of simplicity in implementation of the output signal, which only requires a frequency counter on the part of the user. Implementation of the saw-tooth modulation in a closed loop scheme is performed by varying the frequency of the modulation such that the induced phase shift is the inverse of the rate induce phase shift. Thus, the frequency of the saw-tooth waveform is substantially equal to the proper frequency of the system, but varied to offset the rate-induced phase-shift in the coil.

The bias frequency f_{b} is varied from the proper frequency using a feedback modulation, Δφₘ(t), as follows:

$$\begin{matrix}Δ {φ}_{m} ( t ) = 2 A f {τ}_{L} - 2 A ( i n t ( f * t ) - i n t ( f ( t - {τ}_{L} ) ) \\ = 2 A ( {f}_{p} - δ f ) {τ}_{L} - 2 A ( i n t ( f t ) - i n t ( f ( t - {τ}_{L} ) ) \\ = A - 2 A δ f ( 1 / {f}_{p} ) - 2 A ( i n t ( f t ) - i n t ( f ( t - {τ}_{L} ) ) \\ = - A - 2 A δ f ( 1 / {f}_{p} ) ( n / f ) < t < ( n / f ) + {τ}_{L} ; a n d \\ = A - 2 A δ f ( 1 / {f}_{p} ) ( n / f ) + {τ}_{L} < t < ( n + 1 ) / f .\end{matrix}$$

The above equation is equivalent to:

$$\begin{matrix}Δ {φ}_{m} ( t ) = cos ( - A ( 1 + ( δ f / {f}_{p} ) ) \\ = cos ( A ( 1 - ( δ f / {f}_{p} ) ) \\ = cos ( A ( 1 + ( δ f / {f}_{p} ) ) - cos ( A ( 1 - ( δ f / {f}_{p} ) ) \\ = cos ( A ) * cos ( A ( δ f / {f}_{p} ) ) - sin ( A ) * sin ( δ f / {f}_{p} ) - \\ [ cos ( A ) * cos ( A ( δ f / {f}_{p} ) ) + sin ( A ) * sin ( δ f / {f}_{p} ) ] \\ = 2 sin ( A ) * sin ( δ f / {f}_{p} )\end{matrix}$$

Therefore, in the situation where A=π/2:

Δφₘ(t)=2 sin (δf/fₚ)

where δf is the deviation from fₚ where fₚ is the proper frequency.

The invention has been described above such that the optical signal received from the source-detect coupler 12 is converted into an electrical signal prior to comparison by the phase sensitive detector 23. However, any architecture that would permit a direct comparison of the received optical signal itself to an optical signal representative of the bias modulation signal is considered to be contemplated by the invention as well. What is important is that the saw-tooth modulation signal can be utilized by the detector to provide an indication of rotation of the sensing coil 10.

The present invention is described above in terms of functional block components and various processing steps. Such functional blocks may be realized by any number of hardware or software components configured to perform the specified functions. For example, the present invention may employ various integrated circuit or optical components, e.g., memory elements, processing elements, logic elements, look-up tables, and the like, which may carry out a variety of functions under the control of one or more microprocessors or other control devices. Similarly, the software elements of the present invention may be implemented with any programming or scripting language, such as C, C++, Java, assembler, or the like, with the various algorithms being implemented with any combination of data structures, objects, processes, routines, or other programming elements. Furthermore, the present invention can employ any number of conventional techniques for electronics configuration, optical configuration, signal processing, data processing, and the like.

The particular implementations shown and described herein are examples of the invention and are not intended to otherwise limit the scope of the present invention in any way. Indeed, for the sake of brevity, conventional electronics, optics, software development, and other functional aspects of the systems (and components of the individual operating components of the systems) may not be described in detail. Furthermore, the connecting lines shown in the various figures contained herein are intended to represent exemplary functional relationships or physical or logical couplings between the various elements. Many alternative or additional functional relationships, physical connections, or logical connections may be present in a practical sensor device. Moreover, no item or component is essential to the practice of the invention unless the element is specifically described herein as “essential” or “critical.”

The corresponding structures, materials, acts, and equivalents of all elements in the claims below are intended to include any structure, material, or acts for performing the functions in combination with other claimed elements as specifically claimed. Moreover, the steps recited in any method claims may be executed in any order. The scope of the invention should be determined by the appended claims and their legal equivalents, rather than by the examples given above.

What is claimed is:

1. A gyroscope, comprising:
a light source that is configured to provide electromagnetic radiation for the gyroscope;
a sensing coil that is configured to sense rotation about an axis, the sensing coil having a first end and a second end;
a source-detect coupler comprising an input that is connected to the light source, and further comprising a detected signal output;
a sensing coil coupler that is connected to the first and second ends of the sensing coil that is configured to split light received from the source-detect coupler and transmit the light in both a clockwise and counterclockwise direction in the sensing coil, and transmits light received from the sensing coil back to the source-detect coupler;
a phase modulator coupled to the sensing coil coupler and to the sensing coil that is configured to introduce a phase difference in electromagnetic waves transmitted through it based on a received signal;
a phase modulation driver coupled to the phase modulator, wherein the phase modulator driver is configured to produce a saw-tooth wave output with a phase shift not equal to 2π or integer multiple thereof as the received signal of the phase modulator; and
a phase sensitive detector comprising:
a detected signal input that is connected to the detected signal output of the source-detect coupler;
a bias modulation signal input that is connected to a bias modulation signal output of the phase modulation driver; and
a demodulator system output that is configured to provide a rotation output signal relating to the rotation of the sensing coil;
wherein the phase sensitive detector is configured to produce the rotation output signal utilizing a demodulation function based on inputs from the detected signal input, and the bias modulation signal input.

2. The gyroscope of claim 1, further comprising:
a photodetection system that converts a received light signal from the source-detect coupler into an electrical signal, and provides the electrical signal to the detected signal input of the phase sensitive detector.

3. The gyroscope of claim 1, further comprising at least one of:
a first waveguide coupled between the light source and the source-detect coupler;
a second waveguide coupled between the photodetector and the source-detect coupler;
a third waveguide connected to the source-detect coupler;
a fourth waveguide coupled between the source-detect coupler and the sensing coil coupler; and
a fifth waveguide coupled between the sensing coil coupler and the phase modulator.

4. The gyroscope of claim 3, wherein at least one of the first through fifth waveguides comprises fiber-optic cable.

5. The gyroscope of claim 1, wherein the saw-tooth wave has a frequency equal to a proper frequency of the gyroscope.

6. The gyroscope of claim 1, further comprising:
a feedback mechanism for closed loop operation of the gyroscope that induces a phase difference equal in magnitude and opposite in sign to a phase difference induced by rotation of the gyroscope.

7. The gyroscope of claim 6, wherein the feedback mechanism comprises an additional feedback phase modulator near the sensing coil in an optical path portion used by a counter-propagating electromagnetic wave.

8. A gyroscope, comprising:
a light source that is configured to provide electromagnetic radiation for the gyroscope;
a sensing coil that is configured to sense rotation about an axis, the sensing coil having a first end and a second end;
a source-detect coupler comprising an input that is connected to the light source via a waveguide, and further comprising a detected signal output, the source-detect coupler being further connected to a non-reflective termination arrangement;
a sensing coil coupler that is connected to the first and second ends of the sensing coil that is configured to split light received from the source-detect coupler and transmit the light in both a clockwise and counterclockwise direction in the sensing coil, and transmits light received from the sensing coil back to the source-detect coupler, the sensing coil coupler being further connected to a non-reflective termination arrangement;
a polarizer connected on one side to the sensing coil coupler via a waveguide and connected on another side to the source-detect coupler via a waveguide;
a phase modulator coupled to the sensing coil coupler and to the sensing coil that is configured to introduce a phase difference in electromagnetic waves transmitted through it based on a received signal;
a phase modulation driver coupled to the phase modulator, wherein the phase modulator driver is configured to produce a saw-tooth wave output with a phase shift not equal to 2π or integer multiple thereof as the received signal of the phase modulator;
a phase sensitive detector comprising:
a detected signal input that is connected to the detected signal output of the source-detect coupler;
a bias modulation signal input that is connected to a bias modulation signal output of the phase modulation driver; and
a demodulator system output that is configured to provide a rotation output signal relating to the rotation of the sensing coil;
wherein the phase sensitive detector is configured to produce the rotation output signal utilizing a demodulation function based on inputs from the detected signal input, and the bias modulation signal input.; and
the gyroscope further comprising
a photodetection system that converts a received light signal from the source-detect coupler via a waveguide into an electrical signal, and provides the electrical signal to the detected signal input of the phase sensitive detector;

9. A method for operating a gyroscope, comprising:
generating electromagnetic radiation in a light source;
splitting the generated electromagnetic radiation with a sensing coil coupler;
providing one part of the split electromagnetic radiation in a clockwise direction into a clockwise leg of a sensing coil;
providing another part of the split electromagnetic radiation in a counterclockwise direction into a counterclockwise leg of the sensing coil;
modulating the electromagnetic radiation in one of the clockwise leg and counterclockwise leg of the sensing coil using a saw-tooth waveform having a phase shift not equal to 2π or integer multiple thereof using a modulation signal;
receiving the provided split electromagnetic radiation with the sensing coil coupler after the electromagnetic radiation has passed through the sensing coil;
providing a detected signal representative of the received electromagnetic radiation to a phase sensitive detector;
producing an output signal based on a rotation rate of the sensing coil by demodulating the detected signal using the modulation signal;
utilizing the output signal to provide an indication of the rotation rate.

10. The method according to claim 9, further comprising:
creating the detected signal using a photodetection system that receives electromagnetic radiation that has passed through the sensing coil and transforms the signal into electrical energy.

11. The method according to claim 9, further comprising:
inducing, using a feedback mechanism in a closed loop operation, a phase difference equal in magnitude and opposite in sign to a phase difference induced by rotation of the gyroscope.

12. The method according to claim 11, further comprising:
providing an additional feedback phase modulator near the sensing coil in one of the legs of the sensing coil for the inducing of the phase difference.

13. The method according to claim 9, wherein producing the output signal based on a rotation rate comprises determining the loop transit time or proper frequency.

14. A gyroscope, comprising:
a light source that is configured to provide electromagnetic radiation for the gyroscope;
a sensing coil that is configured to sense rotation about an axis, the sensing coil having a first end and a second end;
a source-detect coupler comprising an input that is connected to the light source, and further comprising a detected signal output;
a sensing coil coupler that is connected to the first and second ends of the sensing coil that is configured to split light received from the source-detect coupler and transmit the light in both a clockwise and counterclockwise direction in the sensing coil, and transmits light received from the sensing coil back to the source-detect coupler;
a phase modulator coupled to the sensing coil coupler and to the sensing coil that is configured to introduce a phase difference in electromagnetic waves transmitted through it based on a received signal;
a phase modulation driver coupled to the phase modulator, wherein the phase modulator driver is configured to produce a periodic wave output with a phase shift not equal to 2π or integer multiple thereof as the received signal of the phase modulator; and
a phase sensitive detector comprising:
a detected signal input that is connected to the detected signal output of the source-detect coupler;
a bias modulation signal input that is connected to a bias modulation signal output of the phase modulation driver; and
a demodulator system output that is configured to provide a rotation output signal relating to the rotation of the sensing coil;
wherein the phase sensitive detector is configured to produce the rotation output signal utilizing a demodulation function based on inputs from the detected signal input, and the bias modulation signal input; the demodulation system output being not identical to the bias modulation signal thus reducing the potential for cross coupling.
